(19) United States
(12) Patent Application Publication
(10) Pub. No.: US 2007/0144184 A1
(43) Pub. Date: Jun. 28, 2007

(54) Enhanced LNG regas

(76) Inventors: Wim van Wijingaarden, Gorinchem (NL); Matthieu Ubas, Rotterdam (NL)

Correspondence Address: LEON D. ROSEN;FREILICH, HORNBAKER & ROSEN, Suite 1220, 10960 Wilshire Blvd., Los Angeles, CA, 90024, US

(21) Appl. No.: 11/317,953

(22) Filed: Dec. 22, 2005

(51) Int. Cl. F17C 9/02

(52) U.S. Cl. 62/50.2

(57) ABSTRACT

Liquefied hydrocarbon gas carried by a tanker (78) is transferred to an import terminal (10) where the liquefied gas is heated to vaporize it and to heat the cold gas to at least −30° C. but preferably about 0° C., with the warmed gas transferred to a gas receiving facility (20, 83). Vaporizing and heating is accomplished by using a large number (more than 10) of vertically mounted air vaporizers (84) of a known type, which use environmental air that flows down the exterior of the finned tubes in which the liquefied or cold gas flows. In the present invention a large number of individual vaporizers are positioned in close proximity to each other, i.e. within a distance that is smaller than half the vertical height of the vaporizer tubes. Their close proximity allows many units to be installed on a small plot space, and also affects their thermal performance.

### BACKGROUND OF THE INVENTION

Gaseous hydrocarbons, which are hydrocarbons that are gaseous at mild environmental temperatures such as 150° C. and atmospheric pressure, are often transported great distances by tanker in liquid form (“liquefied gas”) as LNG (liquefied natural gas) such as LPG (liquefied petroleum gas, commonly containing primarily propane and butane). To keep LNG liquid at approximately atmospheric pressure, it is maintained at a low temperature such as −160° C. in highly thermally insulated tanks. At the tanker offloading destination, the LNG is offloaded to an import terminal where it is vaporized (heated to turn it into a gas) and warmed, and where the warmed gas is passed though a pipeline to users or stored.

The heating of large quantities of liquefied gas can be done by flowing large quantities of seawater though a heat exchanger. However, such use of large quantities of seawater is not acceptable in many areas because large quantities of sea life such as fish eggs and small fish that flow into the sea water intake are destroyed, and because large decreases in local sea water temperature may harm sea life in general. Local regulations are increasingly limiting the use of sea water for such liquefied gas heating, especially in harbors where the seawater is largely isolated from the ocean. The limitations often specify the minimum temperature and maximum outflow rate of sea water. An alternative is the burning of fuel such as hydrocarbon gas to create hot gases that heat the rest of the hydrocarbon gas (e.g. in submerged combustion vaporization), but this uses large amounts of valuable fuel and creates environmentally harmful nitrogen oxides and chemically treated discharge that goes into the sea.

### SUMMARY OF THE INVENTION

In accordance with the present invention, applicant heats liquid hydrocarbon gas that has been transported in a liquefied state (“liquefied gas”) by a tanker across a long distance to an import terminal lying in the vicinity of the final destination of the gas, by a method applied at the import terminal that is of low cost and that is environmentally friendly. The heating of the liquefied hydrocarbon gas is accomplished by vertically-extending air vaporizers, with the design of the air vaporizers known, although previously used in only small quantities and small capacities. In the air vaporizers, liquefied gas is directly or indirectly vaporized by an air flow which passes downward along the outside of the vaporizer tubes or pipes. The environmental air can be passively or actively passed over the vaporizer tubes. Electrically driven air blowers integrated with the air vaporizers can be used to create a forced air flow over a vaporizer that holds liquefied gas to dissipate fog and defrost the tubes. The liquefied gas entering the air vaporizers is at least 10° C. colder than the surrounding environmental temperature, and most of it has a temperature of below −30° C.

During operation of the air vaporizers, a layer of ice (simple ice and/or snow flakes) forms on the outside of the tubes and fins due to the low liquefied gas temperature. The ice layer increases in thickness with the duration of the operation of the vaporizer, and thus reduces its capacity to exchange heat. These vaporizers are operated in a repetitive cycle of vaporizing and defrosting of a limited number of vaporizers at a time, and in cold climates applicant uses blowers to blow air and uses heaters to remove ice. The consistency of the ice layer, and thus the thermal conductivity of the ice layer, varies with the local air humidity and precipitation, with the interior gas temperature, and with the operation cycle of the vaporizer. The performance of these vaporizers is very sensitive to the local air flow pattern and the air temperature distribution as the air exchanges heat with the vaporizer tubes. The vaporizers are normally designed for a certain ice layer thickness build-up. Before this invention, the performance of these vaporizers has been determined empirically, based on a single vaporizer unit, which has limited their use to small-scale applications, often for non-continuous operation.

A novelty of this invention is the idea to use this typically small-scale vaporizer technology for large-scale applications, such as for LNG import terminals. This requires many units positioned close to each other in order to minimize the required plot space and the associated cost. When operating many units in close proximity of each other, their thermal performance will be affected because of their mutual influence on cold air and on air of reduced humidity near the vaporizer tubes due to the condensation or sublimation of the water vapor in the air close to the cold tubes. Also a large cloud of fog can be formed in windless or low wind conditions, which will affect operation in certain applications. It is therefore useful to be able to predict the performance of a large amount of vaporizers in close proximity of each other, before large-scale application is warranted.

A computerized CFD (Computational Fluid Dynamics) calculation method has been developed to enable a reliable prediction in large-scale applications. This model not only allows for the air flow and temperature distribution, but also for ice sublimation and deposition on the tubes, and the prediction of fog, including its thickness and its rate of dispersion. It also calculates the duration of the vaporizing cycle and the defrosting cycle for large numbers of vaporizers, depending on the environmental conditions, spacing, elevation above ground level etc.

The invention is particularly suitable for application on floating offshore or inshore (within about 20 meters of low tide) structures, due to the limited plot space available, and the elevation of the vaporizers above the sea level, which enables a rapid dispersion of any formed fog cloud. However, the invention also may be applied for onshore import terminals where the conditions are acceptable.

A passive air flow over an ambient air vaporizer provides a simple and cost effective system. In cold and very humid environments, the passive ambient air vaporization system can be provided with additional blowers and heating elements (e.g. heating rods or steam pipes) to enhance the defrosting of built-up ice layers on the vaporizer tubes and fins, and melt ice which has fallen from fins onto the deck.

The novel features of the invention are set forth with particularity in the appended claims. The invention will be best understood from the following description when read in conjunction with the accompanying drawings.

### BRIEF DESCRIPTION OF THE DRAWINGS

FIG. 1 is an isometric view of a floating import terminal with LNG storage on a floating structure, with air vaporizers located on the deck of the floating structure.

FIG. 2 is a diagram of a possible heating process performed by the system of FIG. 1.

FIG. 3 is a partial side elevation view of a portion of the import terminal of FIG. 1, showing three air vaporizers.

FIG. 4 is a plan view of the three tubes of the air vaporizers of FIG. 3.

FIG. 5 is a plan view of the import terminal of FIG. 1.

FIG. 6 is a plan view of a floating import terminal with the air vaporizers located on a separate floating barge.

FIG. 7 is a side elevation view of a floating import terminal with air vaporizers located on a separate fixed offshore platform.

FIG. 8 is a plan view of a floating import terminal with air vaporizers located onshore, and with a LNG tanker moored alongside the floating structure that has LNG storage capacity and that is moored to a jetty.

FIG. 9 is a plan view of an LNG tanker moored to a jetty and connected to an onshore import terminal that has LNG storage and vaporization capacity.

FIG. 10 is a sectional view of a portion of a vaporizer system of the invention.

### DESCRIPTION OF THE PREFERRED EMBODIMENTS

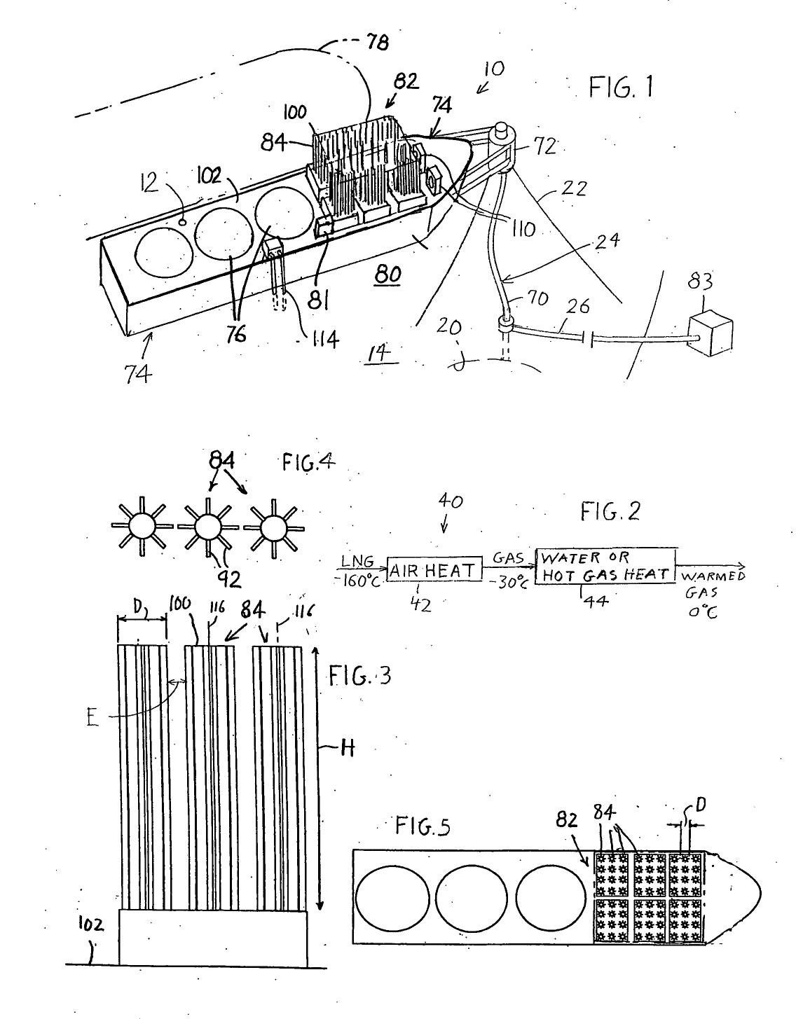

FIG. 1 illustrates an example of a floating import terminal 10 which includes a floating structure 74 (in the case of LNG the structure is also called FSRU, for Floating Storage and Regasification Unit) that has tanks 76 that store liquefied gas. Applicant uses the term “liquefied gas” to mean hydrocarbons that are gaseous at environmental temperatures (e.g. 15° C.) and pressures (e.g. one bar) and that have been cooled below −30° C. to liquefy the hydrocarbons. The floating structure 74 has an inlet 12 through which the liquefied gas is received from a liquefied gas tanker 78. The FSRU floating structure 74 typically stores a large quantity of thousands of tons of liquefied gas, with LNG (liquefied natural gas) maintained at a temperature such as −160° C. to keep it liquid at atmospheric pressure. The FSRU floating structure 74 is moored to the sea floor 14 at an offshore location 80, with a harbor shown.

The cold liquid hydrocarbon gas in the tanks 76 of the floating structure 74 must be heated to a gaseous state, or vaporized. Further, the cold but gaseous hydrocarbons must be further heated to a temperature of more than −30° C., preferably at least 10° C., and usually at least 0° C. to constitute warmed gas, before the gas is transferred though an underwater conduit 24 to a warmed gas receiving facility at 83. Such receiving facility is a facility that uses, stores and/or distributes hydrocarbon gas. Such a gas receiving facility can be an onshore, inshore (close to shore, usually within 20 meters of low tide) or offshore facility, that distributes or uses the gas and/or that stores the gas in pipes of a distribution network (by varying gas pressure). The gas storage facility may instead, or also include an underground cavern 20 that stores the warmed gas (over −30° C.) and later delivers it to the onshore or offshore warmed gas receiving facility. Vaporization is achieved by the use of air vaporizers 84 located on the floating structure. Item 110 in FIG. 1 shows optional air fans which are not to assist the vaporization of LNG, but which are used (if used at all) largely to disperse fog. The presence of wind or a forced air flow is not required for the vaporizers to work. It is a misconception that wind or a forced air flow is needed for the vaporizers to work. Sometimes in cold climates blowers (not shown) are installed at the top of and often integrated with each vaporizer just to enhance the defrosting process in combination with a heat source.

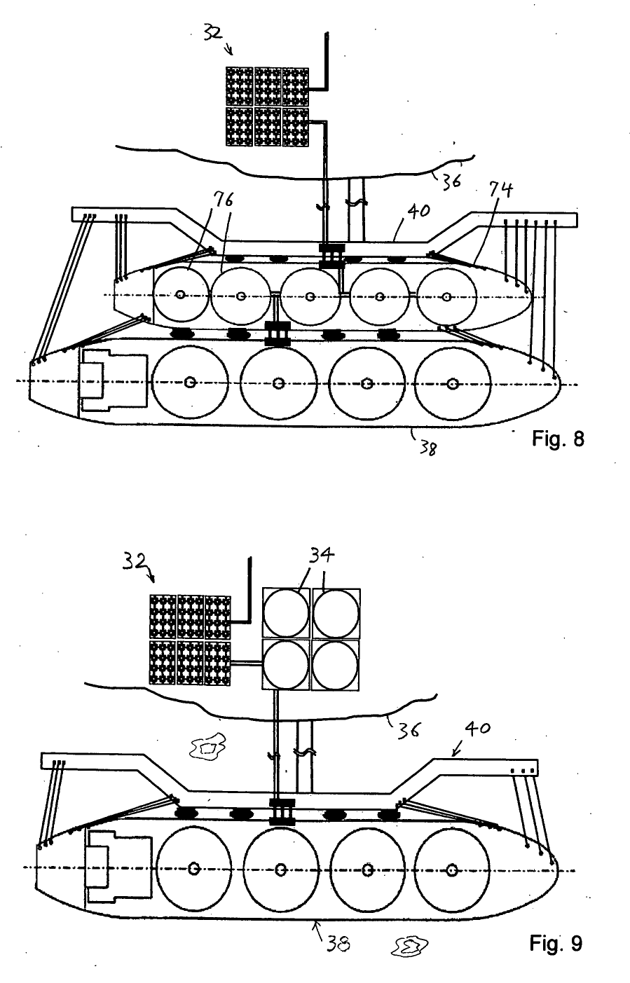

One particular embodiment of the import terminal facility includes the floating structure 74 such as a vessel or a barge that supports a turret 72 that is anchored to the sea floor by catenary lines 22. A fluid swivel on the turret connects to an underwater conduit 24 which includes a riser hose 70 and a sea floor pipeline 26. The sea floor pipeline extends to a gas receiving facility 83. The conduit is also shown connected to a cavern for extra storage of gas. Another general type of import terminal has the storage tanks for the liquefied gas and the offloading system located on one floating vessel or barge (also called FSO, for Floating Storage and Offloading unit). However the vaporization system is located elsewhere, on an auxiliary structure, such as on a separate fixed platform 140 (FIG. 7), on a separate floating barge 120 (FIG. 6), or onshore (FIG. 8), all usually close (within 100 meters) to the FSO. Where the vaporization system is located on a separate facility from the FSO, liquefied gas is transferred from the FSO to the other facility by means of loading arms or flexible hoses such as 30 in FIG. 7, although a subsea cryogenic hose is feasible when the two bodies are not far apart. A floating structure can be moored to a fixed jetty, or can be spread moored or turret moored (weathervaning). The import terminal can be a turret moored or spread moored floating vessel or barge or a seabed founded terminal like a jetty, a tower, a breakwater or a GBS structure. Any type of floating import terminal with tanks that store gas usually lies more than 0.2 kilometer from shore, and usually more than 2 kilometers from shore to minimize danger to persons and structures on shore in the event of a fire or explosion, but inshore is feasible, and it is even feasible to place the vaporization system onshore.

The import terminal using the air vaporization system may also be entirely onshore as shown in FIG. 9 where the vaporization system 32 and storage tanks 34 are located on a shore 36. FIG. 9 shows a jetty 40 built near shore 36 to receive a liquefied gas cargo from a tanker 38 that is moored to the jetty. FIG. 8 shows the tanker 38 moored to the floating structure 74 that contains tanks 76 filled with liquefied air, and both moored to the jetty 40.

As discussed earlier, previous import terminal systems have used sea water to heat the cold (liquid or gaseous and below −30° C.) hydrocarbons that are gaseous when heated, but the resulting large quantities of cold water discharged into the sea can harm sea life. Local authorities are passing increasingly severe law that limit how much water in their area can be cooled and the water discharge temperature. Heating by burning some of the gas stored in the import terminal uses up valuable gas and creates pollution.

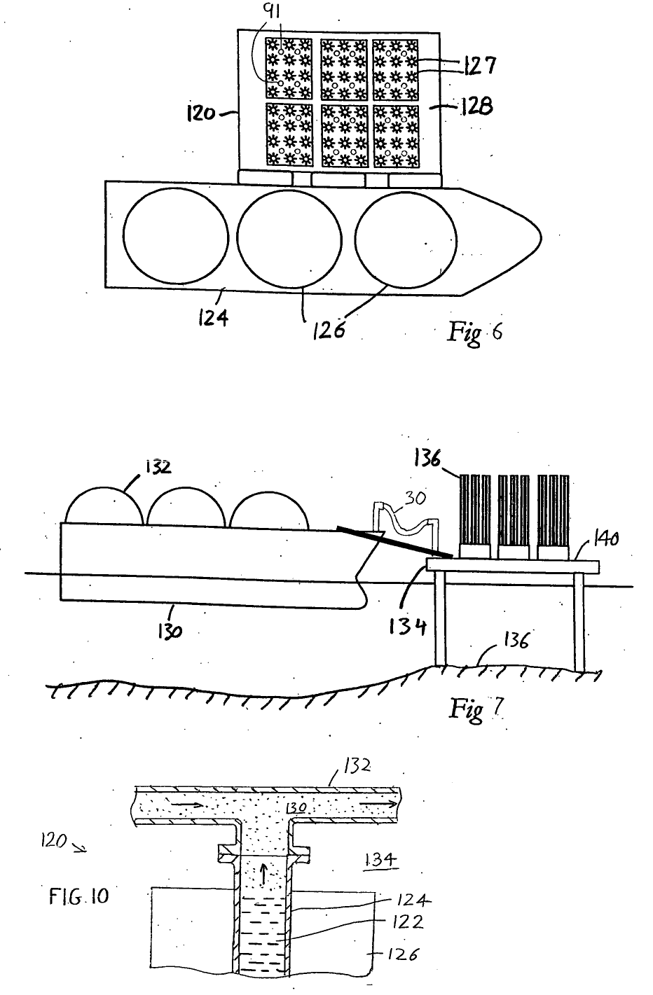

In accordance with the present invention, applicant heats the liquefied gas to turn it into its gaseous phase, and heats the resulting cold (under −30° C.) hydrocarbon gas, at least partially using a large quantity (more than 10) of air vaporizers 84 (FIG. 5). The hydrocarbon gas (in a liquid or cold-gaseous state) is pumped through the air vaporizers and the air vaporizers are positioned in close proximity of each other. The pressure of hydrocarbons can be boosted by a booster pump before LNG is sent through the air vaporizer system and/or afterward, although applicant prefers to at least partially boost the pressure of the LNG before it passes through the vaporizers. The separation distance E (FIG. 3) between vaporizers is smaller than the vertical height H of the vaporizer tubes, and preferably less than half, and more preferably less than 20%, of the vertical height of the vaporizers. The vaporizer height H is a plurality of times its diameter D, and is a plurality of meters, with the vaporizers extending with their axes 116 primarily vertically by a plurality of meters above the deck 102 of the floating structure. The close spacing allows a large number (over 10 and usually at least the 72 shown in FIG. 5) of vaporizers to be positioned in a small space, and allows heating and air blowing to apply to a plurality of vaporizers. The system pumps at least 20 million standard cubic feet of vaporized LNG gas per day.

FIG. 2 is a schematic view of an LNG regas process 40 which includes an air heating stage 42 using air vaporizers, followed by a water or hot gases heating stage 44 (direct or indirect). It should be noted that the second heating step 44 is not mandatory. The second stage is only required in cold climates, i.e. with environmental temperatures below 10° C., where hydrocarbon gases much below 0° C. can cause large ice formations around pipelines that carry the gas.

FIGS. 1, 3, and 4 show a bank 82 of vaporizers 84 on the vessel. A pump 81 pumps cold hydrocarbons (primarily liquefied hydrocarbons) through the air vaporizers. The air around the air vaporizers cools, which causes the cooled air to naturally flow downward, while at the same time exchanging heat with the liquefied gas flowing inside the vaporizers (this is called natural convection). The liquefied gas inside the air vaporizers is vaporized and eventually warmed to near-ambient temperature. The presence of wind enhances the transfer of heat between the air and the liquefied gas, although the presence of wind is not necessary for the proper functioning of the air vaporizers. During the heat-transfer process, a cold layer of ice and/or snow flakes accumulate on the exterior surface of the air vaporizers, which require some of the vaporizers to be taken temporarily offline for defrosting (liquefied gas is not pumped through them). All air vaporizers are defrosted on a rotation basis. When the environmental temperature is cold, such as below 0° C., the defrosting will not occur naturally, so a heating element (e.g. an electric heater or steam heating pipes etc.) indicated at 91 in FIG. 6, can be integrated in the spaces between the pipes/tubes of the air vaporizers. In such cases a blower also is required to force the warmed airflow past the pipes/tubes. This greatly enhances the defrosting of these pipes/tubes of the air vaporizers. Only a limited number of such heaters and blowers is required because of the close proximity of the air vaporizers 84.

Additional means for further direct or indirect heating of the warmed gas can be used when low ambient temperatures prevent the gas from being warmed to approximately 0° C. in the air vaporizers, including the use of flowing sea water (through pipes 114 in FIG. 1) and even hot gas produced by burning some of the hydrocarbon gas stored in the import terminal, or by using hot exhaust gases from combustion equipment. The additional means can be used for melting pieces of ice that fall on deck under the vaporizers.

FIG. 10 shows a portion of one of the vaporizers 120 of a system. LNG 122 is pumped upward through a tall (at least 15 feet, or 5 meters and preferably at least 23 feet, or 7 meters) pipe 124 that carries fins 126. The LNG is pumped at a rate wherein by the time the LNG reaches the top of the pipe 124, it has turned into the gaseous form 130. The cold gas passes along pipe 132 where it is further heated by air 134 in the environment. The LNG (and the resulting gaseous hydrocarbons) moves in parallel through all vaporizers that are suitable for vaporizing LNG (about 50% to 67%), the rest of the vaporizers being in defrosting mode. Any further warming of the cold (below −10° C.) gaseous hydrocarbons is done by other means such as by use of sea water, steam, etc.

There are many advantages in using naturally flowing air vaporizers to heat the liquefied and cold hydrocarbon gas. The use of air vaporizers minimizes the environmental impact dramatically. Air and water pollutants are much lower than for other cryogenic vaporization systems. Also this vaporization system has a lower cost than other methods. Since no sea water is required for the vaporization, the location of the vaporizers can be different from the location where the liquefied gas is stored. In one embodiment, where the vaporizers are located on a separate barge, the storage vessel (the FSO) can be simply a gas carrier vessel that can be chartered and needs no modifications. This will enable a much quicker implementation of the import terminal facility, compared with the building of an onshore terminal. Also, when both the liquefied gas storage facility and the vaporization facility are separate floating bodies, each of them can be easily replaced, as by a larger unit, without having to perform complex modifications to a unit which is in operation.

The invention includes not only the method for vaporizing and warming liquefied hydrocarbons that are gaseous at 15° C., but also covers generating, by means of computer calculation, the predicted thermal performance for a large number of units (more than 10) in close proximity, the build-up of ice on the finned pipes or tubes over time and the prediction of its properties, the flow of air between and around the vaporizers and its temperature distribution in space and over time, and the formation of fog and its distribution in space and over time. These calculations provide the basis for the sizing, the elevation above the surface, the relative positioning and the spacing of the individual vaporizers. When a large number of vaporizers are in close proximity, the well-known heat-transfer mechanisms and calculation methods are not applicable anymore. Therefore a new calculation method has been developed for the proper design of such large vaporizer banks.

Although particular embodiments of the invention have been described and illustrated herein, it is recognized that modifications and variations may readily occur to those skilled in the art, and consequently, it is intended that the claims be interpreted to cover such modifications and equivalents.

What is claimed is:

1. A method for heating hydrocarbons that are gaseous at 15° C. and that have been transported in a tanker as cold liquefied gas and that have been transferred from the tanker to an import terminal for temporary storage, and for heating to a gaseous state and for passing the hydrocarbons in a gaseous state to a gas receiving facility, comprising:
pumping the liquefied gas stored in said import terminal through a plurality of air vaporizers, while exposing said air vaporizers to environmental air that is initially at environmental air temperatures.

2. The method described in claim 1 wherein:
said step of pumping the liquefied gas includes pumping it simultaneously through at least ten vaporizers that each have a height that is plurality of times its average maximum diameter along its length, with the distance between adjacent vaporizers less than half the height of the vaporizers.

3. The method described in claim 1 wherein:
said step of pumping includes operating a pump and flowing the cold liquefied gas through the pump.

4. The method described in claim 1 including:
establishing said air vaporizers on a floating hull that has a deck; and
orienting said pipe sections primarily vertically and exposing to environmental air, air vaporizers with upper ends lying a plurality of meters above the deck of the hull.

5. The method described in claim 1 including:
applying heaters between each of a plurality of pairs of said vaporizers and energizing said heaters when ice forms on said vaporizers to defrost the vaporizers and melt pieces of ice that have fallen onto the deck at the bottom of the vaporizers.

6. The method described in claim 5 including:
blowing air across vaporizers that lie adjacent to heaters that are energized.

7. The method described in claim 1 wherein:
said step of pumping includes pumping an amount of liquefied gas per day through said vaporizer, that comprises at least 20 million standard cubic feet per day of vaporized LNG gas.

8. The method described in claim 1 wherein:
said import terminal includes a floating structure that has storage tanks, and an auxiliary structure lying within 100 meters of the floating structure and connected to the floating structure by a cryogenic conduit, with said air vaporizers located on said auxiliary structure; and including storing liquefied gas obtained from the tanker in said storage tanks, pumping liquefied gas from said storage tanks through said cryogenic conduit, and flowing said liquefied gas from said cryogenic conduit through said vaporizers on said auxiliary structure.

9. Apparatus for heating cold hydrocarbons that have been transported across a sea in a tanker as cold liquefied gas and that have been transferred from the tanker to an import terminal that has a storage tank that stores the cold liquefied gas until it can be heated, the apparatus for heating being useful to heat the transferred liquefied gas to produce gaseous hydrocarbons at a temperature of at least −30° C., for passage from said offloading facility to a gas receiving facility, wherein:
said import terminal includes a plurality of air vaporizers that are exposed to environmental air that is initially at environmental air temperatures, and a pump that pumps said cold liquefied gas through said vaporizers.

10. The apparatus described in claim 9 wherein:
said plurality of vaporizers includes at least ten vaporizers that each has an average maximum diameter and a height of a plurality of meters with the distance between each of a plurality of pair of adjacent vaporizers being less than half the height of said vaporizers.

11. The apparatus described in claim 9 wherein:
said import terminal includes a floating structure that floats in the sea and that has a deck;
said plurality of air vaporizers are each mounted on said floating structure and each vaporizer extends primarily vertically with said air vaporizers having upper ends lying a plurality of meters above said deck.

12. The apparatus described in claim 9 including:
a plurality of heater devices, each lying between pairs of said air vaporizers, to defrost the vaporizers.

13. The apparatus described in claim 9 wherein:
said import terminal includes a floating structure that contains said storage tank that hold liquefied gas, said import terminal also includes an auxiliary structure that lies within 100 meters of the floating structure with said air vaporizers located on said auxiliary structure, and said import terminal also includes a cryogenic conduit that connects said floating and auxiliary structures.
